(19) United States
(12) Patent Application Publication
(10) Pub. No.: US 2020/0374739 A1
(43) Pub. Date: Nov. 26, 2020

(54) INFORMATION PROCESSING METHOD

(71) Applicant: TOYOTA JIDOSHA KABUSHIKI KAISHA, Toyota-shi (JP)

(72) Inventors: Lei ZHONG, Tokyo-to (JP); Ryokichi ONISHI, Tokyo-to (JP)

(73) Assignee: TOYOTA JIDOSHA KABUSHIKI KAISHA, Toyota-shi (JP)

(21) Appl. No.: 15/931,800

(22) Filed: May 14, 2020

(30) Foreign Application Priority Data
May 20, 2019 (JP) 2019-094449

(51) Int. Cl. H04W 28/02; H04W 36/12; H04W 36/30

(52) U.S. Cl. CPC H04W 28/0268; H04W 36/12; H04W 88/16; H04W 28/0252; H04W 36/30

(57) ABSTRACT

A method for relaying packets transmitted from a mobile terminal to an external network using a radio access network including a plurality of base stations, and a core network including a control node, a quality management node, and gateways connected to the external network, the method performs a first establishment step in which the control node establishes a transfer path for the packets transmitted from the mobile terminal by communicating with a first gateway; a decision step in which the quality management node decides to perform data offloading for a predetermined packet; a notification step in which the control node transmits a switching notification to the effect that the transfer path is switched to a second gateway to the base station to which the mobile terminal is connected; and a second establishment step in which the control node requests establishment of the transfer path to the second gateway.

### CROSS REFERENCE TO THE RELATED APPLICATION

This application claims the benefit of Japanese Patent Application No. 2019-094449, filed on May 20, 2019, which is hereby incorporated by reference herein in its entirety.

### BACKGROUND

### Technical Field

The present disclosure relates to mobile communication.

### Description of the Related Art

Mobile communications utilizing radio networks are popular. For example, in 3GPP (3rd Generation Partnership Project), LTE (Long Term Evolution) has been specified, and further, the specifications of 5G (5th Generation mobile communication system) have now been considered and studied.

In mobile communication network systems, the necessity for data offload has been discussed. For example, a user device (UE) communicates with an external network (typically the Internet) connected to a core network. Here, a local network (e.g., a network for caching contents) can be arranged in the core network so as to offload a part of communication, whereby a reduction in network traffic and an improvement in local service quality can be attained.

For example, in Patent Literatures 1 and 2, there are disclosed communication control devices, each of which can offload packets corresponding to specific contents.

### CITATION LIST

Patent Literature 1: International Publication 2018/003480

Patent Literature 2: International Publication 2017/211381

### SUMMARY

However, in the invention described in Patent Literature 1, data offloading to a local network, which has been arranged by a mobile network administrator, can be carried out, but the data thus offloaded can not be directed to a wide area network (e.g., the Internet, etc.).

In addition, in the invention described in Patent Literature 2, an additional IP session for data offloading is provided, which results in a disadvantage in that scalability is lacking. For example, although a plurality of communication paths or routes can be formed by the use of different APN settings, but it is difficult to switch over among the communication paths in a dynamic manner.

The present disclosure has been made in consideration of the above-mentioned problems, and has for its object to achieve scalability as well as highly flexible data offloading in mobile communication.

The present disclosure in its one aspect provides an information processing method for relaying packets transmitted from a mobile terminal to an external network using a radio access network including a plurality of base stations that communicate with the mobile terminal, and a core network including a control node, a quality management node, and gateways connected to the external network.

The method comprises a first establishment step in which the control node establishes a transfer path for the packets transmitted from the mobile terminal by communicating with a first gateway; a decision step in which the quality management node decides to perform data offloading for a predetermined packet; a notification step in which the control node transmits a switching notification to the effect that the transfer path is switched to a second gateway to the base station to which the mobile terminal is connected; and a second establishment step in which the control node requests establishment of the transfer path to the second gateway.

Here, note that the present disclosure can be specified as an information processing method including at least a part of the above-mentioned steps. In addition, the present disclosure can also be specified as an information processing apparatus including at least a part of the above-mentioned steps. The above-mentioned processings, units or devices can be implemented in various combinations thereof, as long as technical inconsistency does not occur.

According to the present disclosure, it becomes possible to selectively perform data offloading in one IP session, thus making it possible to achieve scalability as well as highly flexible data offloading in mobile communication.

### BRIEF DESCRIPTION OF THE DRAWINGS

FIG. 1 is an overall schematic configuration view of a mobile communication system according to a conventional art.

FIG. 2 is a configuration view of a mobile communication system according to a first embodiment.

FIG. 3 is a view explaining a module configuration of a control node.

FIG. 4 is a communication sequence diagram in the first embodiment.

FIG. 5 is another communication sequence diagram in the first embodiment.

FIG. 6 is a configuration view of a mobile communication system according to a second embodiment.

FIG. 7 is a communication sequence diagram in the second embodiment.

### DESCRIPTION OF THE EMBODIMENTS

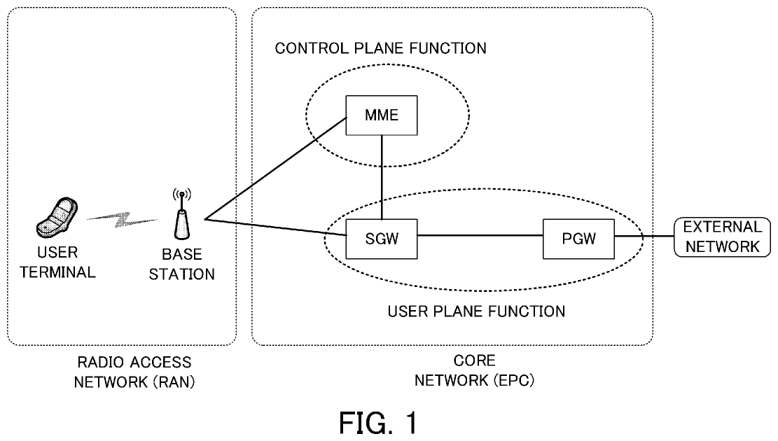

FIG. 1 is an overall schematic configuration view illustrating a mobile or cellular communication system according to a conventional art. The mobile communication system is a system conforming to the LTE (Long Term Evolution) standard, which is hereinafter also referred to as an LTE system. As illustrated in FIG. 1, the LTE system is composed of including a radio access network (RAN, Radio Access Network) and a core network (EPC, Evolved Packet Core). The architecture of the EPC includes an architecture having a control plane function and a user plane function separated from each other. An external network (typically the Internet) is connected to the user plane function.

The radio access network (RAN) is, for example, a network based on the radio access procedure specified in 3GPP, and includes a user terminal (UE) and a radio base station (eNodeB). The core network (EPC) is connected to the radio access network.

The core network (Evolved Packet Core, EPC) includes an architecture (CUPS, Control and User Plane Separation) in which the control plane function and the user plane function are separated from each other.

The control plane function includes an MME (Mobile Management Entity) that is a control entity to manage the movement and communication path of the user terminal, an SGW-C(Serving Gateway Control Plane) that controls the relay of user data, and a PGW-C (Packet Data Network Gateway Control Plane) that manages the relay to the external network. In addition, the SGW-U includes an SGW-U (Serving Gateway User Plane) that performs the relay of user data, and a PGW-U (Packet Data Network Gateway User Plane) that is a relay point to the external network (in FIG. 1, illustrated as SGW and PGW, respectively).

In the LTE network, the MME, which has received a communication request from the user terminal, sets a transfer path (bearer) of the user data. The bearer is a logical communication path or route from the user terminal to the external network, by which a route composed of the base station—SGW—PGW—the external network is established, for example.

However, in such a system, the user data transmitted from a plurality of user terminals pass through the same SGW, so there arises a problem that load sharing or distribution is difficult. Although in the apparatus described in Patent Literature 1, a route or path from the SGW to the local network is branched so as to perform the offloading of data, but a route up to the SGW is common, so there is a limitation on load sharing.

In order to cope with this problem, in an information processing method according to the present disclosure, a control node establishes a transfer path for a packet transmitted from a mobile terminal by communicating with a first gateway, and a quality management node decides to perform data offloading for a predetermined packet.

In addition, the control node transmits, to the base station to which the mobile terminal is connected, a switching notification to the effect that the transfer path is switched to a second gateway, and the control node requests an establishment of the transfer path to the second gateway.

In the present disclosure, the control node is configured to be capable of setting a plurality of transfer paths (e.g., bearers in an LTE network, IP flows in a 5G network, etc.) of the user data, and in cases where it is decided to perform data offloading, the control node notifies the switching of the transfer path to base stations. Then, a base station located within the radio access network switches the gateway through which the user data is transferred, according to the notification received. According to such a configuration, a communication path can be set in a flexible manner, thereby making it possible to attain load sharing within the core network.

Here, the quality management node may be a node to perform QoS control in the core network, and may decide to perform data offloading for the predetermined packet based on a predetermined QoS policy.

In cases where the mobile communication network is provided with a node that performs QoS control, it can be decided, based on a predetermined policy on QoS, which type of data is offloaded. For example, the data to be offloaded may be decided by utilizing a QoS policy that has been decided in advance with respect to the packet transmitted.

Moreover, the quality management node may decide to perform the data offloading based on an attribute of the mobile terminal or an attribute of the packet transmitted from the mobile terminal.

For example, load sharing can be carried out based on an attribute or classification (the type of communication, the type of data, the type of a communication destination server, the logical place of the communication destination server, etc.) of the user data, and/or an attribute or classification (a current position, an identifier, etc.) of the mobile terminal.

The method according to the present disclosure may also be characterized in that it is targeted to an information processing method for an LTE network, wherein the transfer path is a bearer. The present disclosure can be suitably applied to the LTE network. Of course, the present disclosure can also be applied to next-generation networks such as a 5G network.

Further, in cases where switching is made among the transfer paths, the control node may also notify the cancellation or deletion of the established transfer path to the first gateway.

Furthermore, upon reception of the switching notification, the base station may switch over a destination of a corresponding packet from the first gateway to the second gateway.

According to such a configuration, in a stage before the user data reaches the core network, the communication path of the user data can be switched over, thus making it possible to contribute to the decrease of load.

### First Embodiment

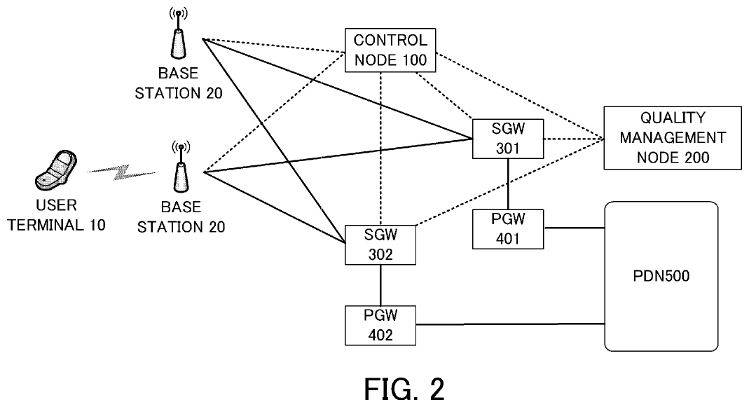

FIG. 2 is an overall schematic configuration view of a mobile or cellular communication system according to a first embodiment of the present disclosure.

The mobile communication system according to the first embodiment is composed of a plurality of user terminals 10, a plurality of base stations 20, a control node 100, a plurality of SGWs (Serving Gateways), a plurality of PGWs (Packet DataNetwork Gateways), and a quality management node 200.

The mobile communication system illustrated in FIG. 2 has an architecture in which a device to control and manage a control plane function (the control node 100) and a device to control and manage a user plane function (the quality management node 200, the SGWs, and the PGWs) are separated from each other.

Here, note that in this example, two SGWs (denoted by reference numerals 301, 302) and two PGWs (denoted by reference numerals 401, 402) are illustrated, but the number of these gateways is not limited to these. In this embodiment, the plurality of SGWs are collectively referred to as the SGW 300, and the plurality of PGWs are collectively referred to as the PGW 400.

The control node 100 is a device that performs position control of user terminals, paging (calling), and movement control such as handover. The control node is also referred to as an MME (Mobile Management Entity). In addition, the control node 100 provides a ciphering function between itself and the user terminals. Moreover, based on a request from a user terminal 10, the control node 100 performs the establishment or deletion of a bearer which is a logical path or route between the user terminal 10 and an external network. The control node 100 processes only a control signal, but does not perform the handling of the user data. The control node 100 has a configuration capable of performing control in cooperation with an SGSN (Serving General Packet Radio Service Support Node) in 3G.

The quality management node 200 is a policy control device that decides the execution of the QoS control with respect to the user data, and charging control rules. The quality management node 200 is also referred to as a PCRF (Policy and Charging Rules Function). For example, the quality management node 200 decides a QoS value according to the content of the user data, and notifies the value thus decided to the devices (the SGW 300, the PGW 400 and the base station 20) on the route of the user data. With this, the QoS control for each user data becomes possible.

In this embodiment, the quality management node 200 decides to offload predetermined user data based on the QoS policy. Specific processing thereof will be described later.

The SGW 300 is a gateway through which packets transmitted as user data are relayed. The SGW 300 is capable of communicating with the plurality of base stations 20, and tracking a user terminal that performs a handover. In addition, the SGW 300 can perform the resetting of a bearer by cooperating with the control node 100 as needed.

The PGW 400 is a gateway that is used as a connection point for the external network. Specifically, the PGW 400 performs the application of an IP address to the user terminal, user authentication for a packet network, and packet control at an application level.

The PDN 500 is an external network (i.e., Packet Data Network) connected to a core network, and is typically the Internet. The various types of servers (a web server, a mail server, a contents server, etc.), which communicate with the user terminal 10, are arranged in the PDN 500.

In the system according to this embodiment, the PGW 401 and the PGW 402 provide access to the external network from respectively different points or service requirements. With this, the system can provide a more suitable access path or route to a server on the external network.

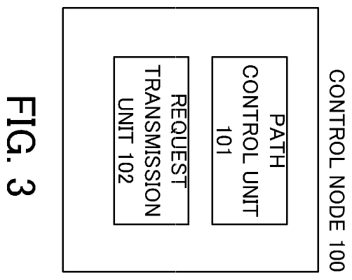

Next, reference will be made to the control node 100 according to this embodiment. FIG. 3 is a block diagram illustrating the functional configuration of the control node 100. The illustrated functions may be achieved by executing a program stored in a storage device by a CPU.

A path control unit 101 sets a communication path for a packet that is transmitted by the user terminal 10. Specifically, the path control unit 101 sets a logical communication path (bearer) through which the packet transmitted from the user terminal 10 reaches the external network. The bearer is updated based on the communicating state, the handover state, etc., of the user terminal 10 by the control node 100, as necessary.

A request transmission unit 102 notifies the bearer decided by the path control unit 101 to the respective components of the system. Specifically, a request for setting a new bearer (a bearer setting request), a request for deleting or canceling the set bearer, or the like is transmitted to the SGW 300, the user terminal 10, and the base station 20 connected by the user terminal 10, all of which exist on the path.

In this embodiment, the path control unit 101 is configured to be capable of setting an additional bearer (Dedicated Bearer), in addition to a default bearer (Default Bearer) that is set as a default. The default bearer and the additional bearer differ from each other in that the SGWs to be passed through are different from each other. In this embodiment, the default bearer is a path or route that passes through the SGW 301 and the PGW 401, and arrives at the PDN 500. In addition, the additional bearer is a path or route that passes through the SGW 302 and the PGW 402, and arrives at the PDN 500.

Next, reference will be made to the operation of the mobile communication system according to this embodiment.

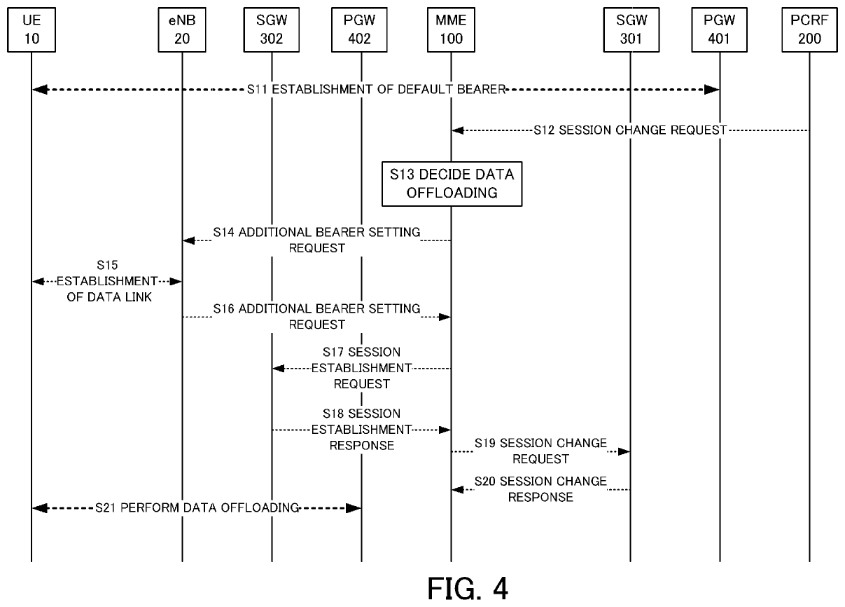

FIG. 4 is a communication sequence diagram on the settings of the bearers and sessions between the user terminal 10 and the respective components that constitute the mobile communication network. Here, note that UE and eNB denote the user terminal and the base station, respectively.

When the user terminal 10 starts communication, the establishment of the default bearer is first carried out (step S11).

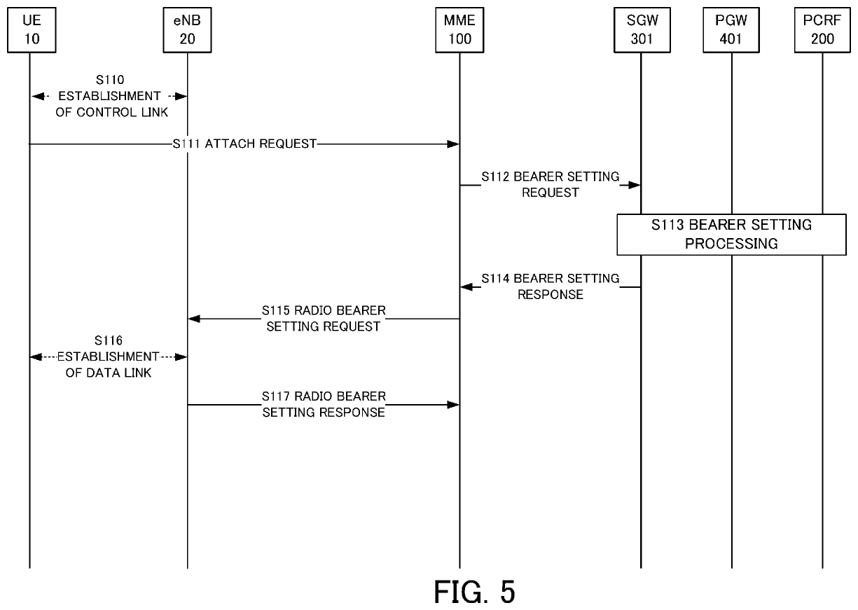

FIG. 5 is a sequence diagram illustrating establishment processing of the default bearer in more detail.

First, at step S110, the user terminal 10 establishes a control link between itself and the base station 20, and at step S111, the user terminal 10 transmits an attach request to the control node 100. The attach request includes information for identifying the PDN 500, etc., which is an external network.

Subsequently, the control node 100 starts to set a communication path to the PDN 500. Specifically, the control node 100 decides an SGW used as an anchor point based on the received attach request and the information on the user terminal 10 (subscriber information, the situation on movement, etc.). Here, it is assumed that the SGW 301 is selected as such.

Then, the control node 100 transmits a bearer setting request to the SGW 301 thus selected (step S112).

Thereafter, the SGW 301 and the PGW 401 perform the processing of setting the bearer according to the bearer setting request (i.e., the processing of establishing a communication session) (step S113). In this step, the setting of a transfer path for the packet between the SGW 301 and the PGW 401, the assignment of IP addresses, etc., are carried out. The communication path between the SGW 301 and the PGW 401 is established in this step.

Here, note that in this step, the quality management node 200 may perform processing on QoS control. For example, a QCI value (to be described later) may be decided according to the classification of the packet which is going to be transmitted, and the SGW 301 and the PGW 401 may decide the content of the flow control to be carried out, based on the QCI value thus decided.

When the setting of the bearer has been completed, a bearer setting response is returned to the control node 100 at step S114. The bearer setting response includes information on the SGW 301, information on an IP address assigned to the user terminal 10, etc.

Subsequently, the control node 100 transmits a radio bearer setting request to the base station 20 (step S115).

Based on the radio bearer setting request, the base station 20 creates a path or route connecting between the user terminal 10 and the SGW 301, and then establishes a radio data link to the user terminal 10 (step S116). When the connection has been established, a response to the effect that the setting of the radio bearer has been completed (i.e., the processing with respect to the attach request has been completed) is returned to the control node 100 (step S177).

In this step, a communication path (radio bearer) between the user terminal 10 and the SGW 301 is established.

By the above processing, the establishment of the default bearer between the user terminal 10 and the PGW 401 has been completed, so that communication from the user terminal 10 to the PDN 500 becomes possible.

The processing explained with reference to FIG. 5 is a bearer setting procedure according to a conventional art.

Returning to FIG. 4, the explanation will be continued.

In the mobile communication network according to this embodiment, the quality management node 200 decides that a different bearer should be assigned to a packet transmitted by the user terminal 10 based on a QoS policy set in advance.

Here, the QoS policy will be explained. The quality management node 200 is a device that performs control on a network policy or charging (or accounting). The quality management node 200 assigns a QCI (QoS Class Identifier) to user data, and performs control to the SGWs and the PGWs so as to provide bandwidth guarantee and delay time guarantee.

In this embodiment, the control node 100 decides, based on the QCI corresponding to the user data, whether to use the route that uses the path or route passing through the SGW 301 (i.e., the default bearer), or the path or route passing through the SGW 302 (i.e., additional bearer). In other words, the quality management node 200 decides, based on the holding QoS policy, which QoS flow uses which bearer.

Here, note that in this embodiment, an example is given in which a plurality of bearers are switched over from one to another based on the QCI, but the switching of the bearers may be carried out based on other references or criteria. For example, the switching of the bearers may be carried out according to the classification of the server with which the user terminal 10 communicates, the network topological distance to the server, the classification of the user terminal 10, the geographical location of the user terminal 10, and the communication application which the user terminal 10 uses, etc. Moreover, the switching of the bearers may also be carried out based on the result of an adjustment with an external application server.

In the example of FIG. 4, when the quality management node 200 decides to switch over from the default bearer to the additional bearer, data requesting the switching of the bearers (session change request) is transmitted to the control node 100 (step S12).

Then, at step S13, the control node 100 decides to start switching (data offload) processing of the bearers.

Here, note that in this example, it is exemplified that the quality management node 200 switches over between the bearers, but the switching of the bearers may be carried out only by the control node 100. For example, the quality management node 200 may provide only a policy, and the control node 100 may decide a communication for which data offload is to be performed and an offload destination according to the policy.

At step S14, the control node 100 transmits an additional bearer setting request to a radio access network (base station 20).

Based on the request, the base station 20 changes the communication path or route connecting between the user terminal 10 and the SGW 301 to a path or route connecting between the user terminal 10 and the SGW 302, and then establishes a radio data link to the user terminal 10 (step S15). When the connection (radio data link) is established, a response to the effect that the setting of the additional bearer is completed is returned to the control node 100 (step S16).

With this step, a communication path (radio bearer) between the user terminal 10 and the SGW 302 is established.

Further, the control node 100 requests the establishment of a session to the SGW 302, which is an SGW utilized by the additional bearer (step S17).

The SGW 302, which has received the request, performs the processing of setting a bearer between itself and the PGW 402 (the processing of establishing a session). Here, the setting of a transfer path for the packet between the SGW 302 and the PGW 402, the assignment of IP addresses, etc., are carried out. With this step, a communication path between the SGW 302 and the PGW 402 is established. Here, note that the quality management node 200 may participate in the establishment of this session.

When the session is established, a response to that effect is transmitted from the SGW 302 to the control node 100.

Subsequently, the control node 100 transmits a session change request to the SGW 301 so that the session already established by the default bearer should be updated, as needed (step S19). In addition, the SGW 301 updates the already established session according to the session change request, and returns a response to that effect (step S20). With this, the communication path between the SGW 301 and the PGW 401 is updated.

According to the processing explained above, it becomes possible for the user terminal 10 to communicate with the external network so as to transmit thereto the data to be offloaded by way of the PGW 402.

In the first embodiment, the quality management node 200 switches the logical communication path to the external network by utilizing a mechanism of performing QoS control. This can achieve data offloading with high scalability. In addition, the communication path can be branched within the radio access network, so it is possible to avoid that load concentrates on a specific gateway in the core network.

### Second Embodiment

Although in the first embodiment, there has been described the example in which the present disclosure is applied to an LTE network, the present disclosure can also be applied to next-generation networks such as 5G networks.

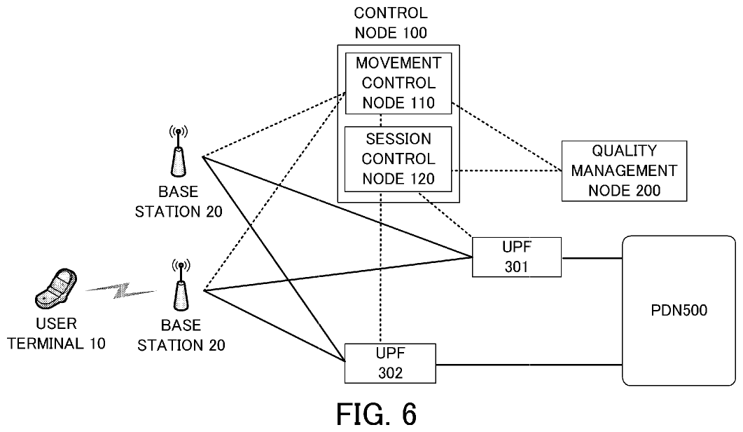

FIG. 6 is an overall schematic configuration view of a mobile or cellular communication system according to a second embodiment of the present disclosure. The mobile communication system according to the second embodiment is a communication system utilizing a 5G network.

In comparison with the LTE network, the 5G network is different therefrom in that a control node is divided into a node for managing the movement of user terminals, and a node for managing sessions. In the second embodiment, the control node 100 is divided into a movement control node 110 for managing mobility management, and a session control node 120 for managing session management. The former is also referred to as an AMF (Access and Mobility management Function), and the latter is also referred to as an SMF (Session Management Function).

In addition, the 5G network is different from the LTE network in that a UPF (User Plane Function) plays a user plane functional role. The UPF in the 5G network includes the functions of an SGW and a PGW in the first embodiment, and provides a function that is specialized in user plane processing.

The quality management node 200 is also referred to as a PCF (Policy Control function), and manages control on QoS, as in the LTE network.

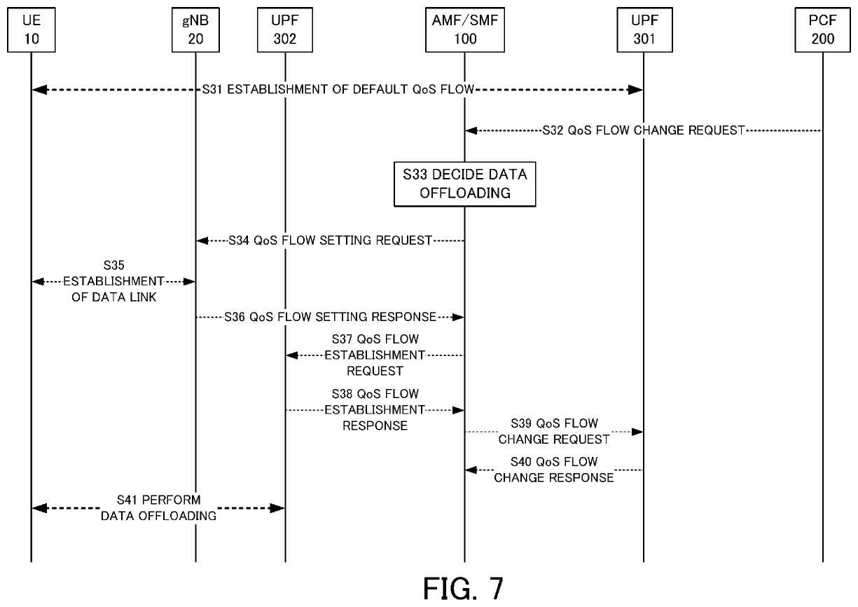

FIG. 7 is a communication sequence diagram the settings of communication paths and sessions in the second embodiment. Here, note that gNB denotes a base station.

In the LTE network, QoS control is performed for each bearer, but in the 5G network, QoS control can be made for each IP flow, instead of for each bearer. A logical communication path set in the second embodiment is referred to as a QoS flow.

Steps S31 through S41 in the second embodiment correspond to steps S11 through S21 in the first embodiment, respectively. The operation of the second embodiment is basically common to that of the first embodiment, except for the name of each component that constitutes a mobile communication network, the setting of each QoS flow that is performed instead of the setting of each bearer, the utilization of a 5QI (5G QoS Indicator) value for QoS control that is performed by the quality management node 200, and so on.

### Modifications

The above-mentioned embodiments are only some examples, and the present disclosure can be implemented while being changed or modified suitably without departing from the spirit and scope of the disclosure.

For example, the processings, units and devices explained in this disclosure can be implemented in various combinations thereof, as long as technical inconsistency does not occur.

Moreover, the processing(s) explained as carried out by a single device may be carried out by a plurality of devices. Alternatively, the processing(s) explained as carried out by different devices may be carried out by a single device. In a computer system, whether each function of the disclosure is achieved by what kind of hardware configuration (server configuration) can be changed in a flexible manner.

The present disclosure can also be achieved by supplying a computer program to a computer which implements the functions explained in the above-mentioned embodiments, and by reading out and executing the program by one or more processors of the computer. Such a computer program may be supplied to the computer by a non-transitory computer readable storage medium which can be connected with a system bus of the computer, or may be supplied to the computer through a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, any type of medium suitable for storing electronic commands.

What is claimed is:

1. An information processing method for relaying packets transmitted from a mobile terminal to an external network using a radio access network including a plurality of base stations that communicate with the mobile terminal, and a core network including a control node, a quality management node, and gateways connected to the external network, the method performing:
a first establishment step in which the control node establishes a transfer path for the packets transmitted from the mobile terminal by communicating with a first gateway;
a decision step in which the quality management node decides to perform data offloading for a predetermined packet;
a notification step in which the control node transmits a switching notification to the effect that the transfer path is switched to a second gateway to the base station to which the mobile terminal is connected; and
a second establishment step in which the control node requests establishment of the transfer path to the second gateway.

2. The information processing method according to claim 1, wherein
the quality management node is anode that performs QoS control in the core network, and decides to perform data offloading with respect to the predetermined packet based on a predetermined QoS policy.

3. The information processing method according to claim 1, wherein
in the decision step, the quality management node decides to perform the data offloading based on an attribute of the mobile terminal or the packets transmitted from the mobile terminal.

4. The information processing method according to claim 1, wherein
the method is an information processing method targeted for an LTE network, wherein the transfer path is a bearer.

5. The information processing method according to claim 1, wherein
in the second establishment step, the control node notifies the deletion of the established transfer path to the first gateway.

6. The information processing method according to claim 1, wherein
upon reception of the switching notification, the base station switches over a destination of a corresponding packet from the first gateway to the second gateway.
